(19) United States
(12) Patent Application Publication
(10) Pub. No.: US 2025/0319536 A1
(43) Pub. Date: Oct. 16, 2025

(54) Steak Cleaning System with Adjustable Top and Bottom Scrapers

(71) Applicant: Midwest Machine, LLC, Amarillo, TX (US)

(72) Inventors: Steve Dunivan, Amarillo, TX (US); Matt Keifer, Amarillo, TX (US)

(21) Appl. No.: 19/248,246

(22) Filed: Jun. 24, 2025

Related U.S. Application Data
(63) Continuation of application No. 16/776,413, filed on Jan. 29, 2020, now abandoned.
Application No. 16/776,413 is a continuation-in-part of application No. 16/751,100, filed on Jan. 23, 2020, now Pat. No. 11,498,138.
(60) Provisional application No. 62/796,027, filed on Jan. 23, 2019.
(60) Provisional application No. 62/798,181, filed on Jan. 29, 2019.

(51) Int. Cl. B23D 53/00; G05B 19/19

(52) U.S. Cl. CPC B23D 53/008; G05B 19/19; G05B 2219/45144

(57) ABSTRACT

A meat cleaning system for cleaning debris from a meat cut. The meat cleaning system comprises a control system, one or more conveyor assemblies having a first end and a second end, a first scraping assembly for scraping a bottom surface of the meat cut, a second scraping assembly for scraping a top surface of the meat cut, a tower housing the second scraping assembly, a base supporting the one or more conveyor assemblies, the first scraping assembly and the tower, one or more motors each configured to selectively drive the first scraping assembly, the second scraping assembly and the one or more conveyor assemblies, and one or more sensors for measuring a thickness of the meat cut. The control system comprises a memory having an application, one or more processors, and a communication hardware. The application is executed using the one or more processors.

### CROSS-REFERENCE TO RELATED APPLICATIONS

This application is a continuation-in-part of U.S. patent application Ser. No. 18/155,606, was filed and is currently under a Notice of Allowance, with the Notice of Allowance Mailed and Application Received on Mar. 20, 2025. The subject matter of the present application shares some, but not all, subject matter with the aforementioned prior application. Further, Ser. No. 18/155,606 claimed benefit to Ser. No. 16/776,413, filed on Jan. 29, 2020, now abandoned.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

In the meat processing industry, preparing steaks for packaging requires the removal of bone dust, fragments, and fat. Conventional approaches often rely on manual scraping or automated systems that flip the steak to clean both sides. These methods can be inefficient, time- consuming, and inconsistent in achieving thorough cleaning. There exists a need for an advanced system capable of cleaning both the top and bottom surfaces of a steak simultaneously without flipping, enhancing efficiency and quality control in meat processing.

No prior art is known to the Applicant.

### BRIEF SUMMARY OF THE INVENTION

A meat cleaning system 100 for cleaning debris from a meat cut 500. Wherein: said meat cleaning system 100 comprises a control system 102, one or more conveyor assemblies 112 having a first end 200 and a second end 202, a first scraping assembly 114 for scraping a bottom surface 1104 of said meat cut 500, a second scraping assembly 900 for scraping a top surface 1106 of said meat cut 500, a tower 104 housing said second scraping assembly 900, a base 106 supporting said one or more conveyor assemblies 112, said first scraping assembly 114 and said tower 104, one or more motors 108 each configured to selectively drive said first scraping assembly 114, said second scraping assembly 900 and said one or more conveyor assemblies 112, and one or more sensors 110 for measuring a thickness of said meat cut 500. Said control system 102 comprises a memory 1202 having an application 1204, one or more processors 1206, and a communication hardware 1208. Said application 1204 is executed using said one or more processors 1206. Said meat cleaning system 100 is configured for moving said meat cut 500 from the first end 200 to the second end 202 of said one or more conveyor assemblies 112, scraping the bottom surface 1104 of said meat cut 500 using said first scraping assembly 114, scanning the top surface 1106 of said meat cut 500, calculating a thickness of said meat cut 500, adjusting a vertical position 1006 of said second scraping assembly 900, and scraping said top surface 1106 of said meat cut 500 using said second scraping assembly 900. Said first scraping assembly 114 comprises a plurality of fingers 502 and a plurality of rotary scrapers 504. Said one or more conveyor assemblies 112 are configured to move said meat cut 500 toward said first scraping assembly 114. Said plurality of fingers 502 are configured to press down on the top surface 1106 of said meat cut 500 and said plurality of rotary scrapers 504 can scrape the bottom surface 1104 of said meat cut 500.

The meat cleaning system 100 for cleaning debris from the meat cut 500. Wherein: said meat cleaning system 100 comprises the control system 102, one or more conveyor assemblies 112 having the first end 200 and the second end 202, the first scraping assembly 114 for scraping the bottom surface 1104 of said meat cut 500, the second scraping assembly 900 for scraping the top surface 1106 of said meat cut 500, the tower 104 housing said second scraping assembly 900, the base 106 supporting said one or more conveyor assemblies 112, said first scraping assembly 114 and said tower 104, one or more motors 108 each configured to selectively drive said first scraping assembly 114, said second scraping assembly 900 and said one or more conveyor assemblies 112, and one or more sensors 110 for measuring a thickness of said meat cut 500. Said control system 102 comprises the memory 1202 having the application 1204, one or more processors 1206, and the communication hardware 1208. Said application 1204 is executed using said one or more processors 1206. Said meat cleaning system 100 is configured for moving said meat cut 500 from the first end 200 to the second end 202 of said one or more conveyor assemblies 112, scraping the bottom surface 1104 of said meat cut 500 using said first scraping assembly 114, scanning the top surface 1106 of said meat cut 500, calculating a thickness of said meat cut 500, adjusting the vertical position 1006 of said second scraping assembly 900, and scraping said top surface 1106 of said meat cut 500 using said second scraping assembly 900.

### BRIEF DESCRIPTION OF THE SEVERAL VIEWS OF THE DRAWING

FIG. 1 illustrates a perspective overview of a meat cleaning system 100.

FIG. 2 illustrates a perspective overview of said meat cleaning system 100 from a second viewpoint.

FIG. 3 illustrates a perspective overview of said meat cleaning system 100 with a portion of mechanical enclosure 208 removed.

FIG. 4 illustrates a lower perspective view of said meat cleaning system 100.

FIG. 5A and 5B illustrate a perspective overview and lower view of said one or more conveyor assemblies 112, said first scraping assembly 114 and said one or more sensors 110 with a meat cut 500.

FIG. 6A and 6B illustrate a perspective overview and an elevated side view of said plurality of rotary scrapers 504.

FIG. 7 illustrates a perspective overview of a portion of said tower 104.

FIG. 8 illustrates a rear side overview of said tower 104.

FIG. 9 illustrates a rear side overview of said tower 104 with a portion of said encasement 702 removed.

FIG. 10 illustrates a front side overview of said tower 104 with a portion of said encasement 702 removed.

FIG. 11 illustrates an elevated front view of said meat cleaning system 100 showing the arrangement of said first scraping assembly 114, said second scraping assembly 900, and said tower 104, said one or more sensors 110, said top scraping assembly 1000, and said one or more conveyor assemblies 112.

FIG. 12 illustrates a block diagram of said control system 102.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system-and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

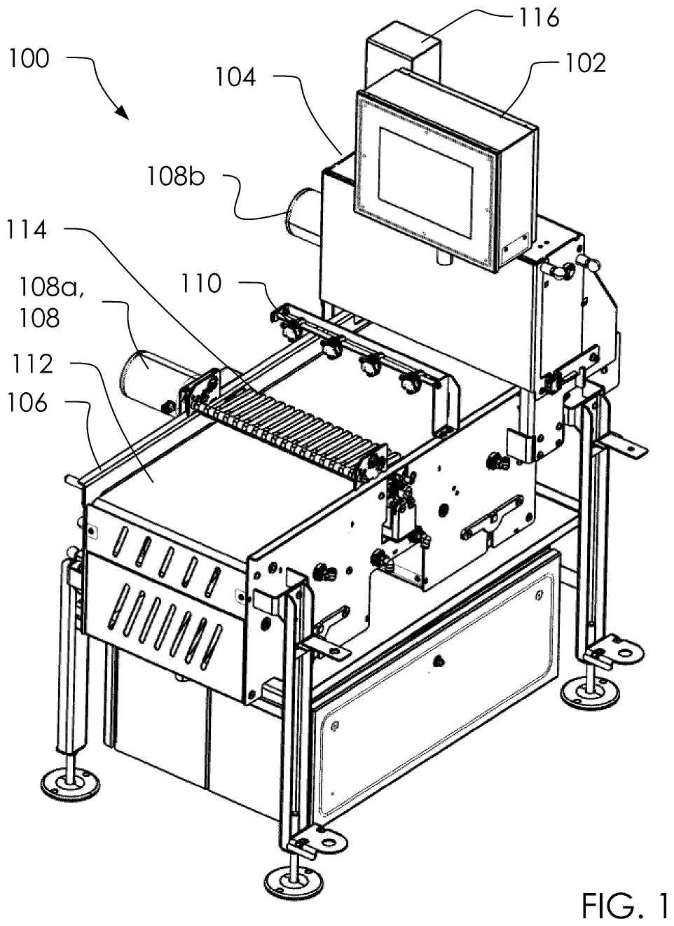

FIG. 1 illustrates a perspective overview of a meat cleaning system 100.

In one embodiment, said meat cleaning system 100 can comprise a control system 102, a tower 104, a base 106, one or more motors 108, one or more sensors 110, one or more conveyor assemblies 112, a first scraping assembly 114, a vertical actuator 116.

Said one or more motors 108 can comprise a first motor 108a and a second motor 108b.

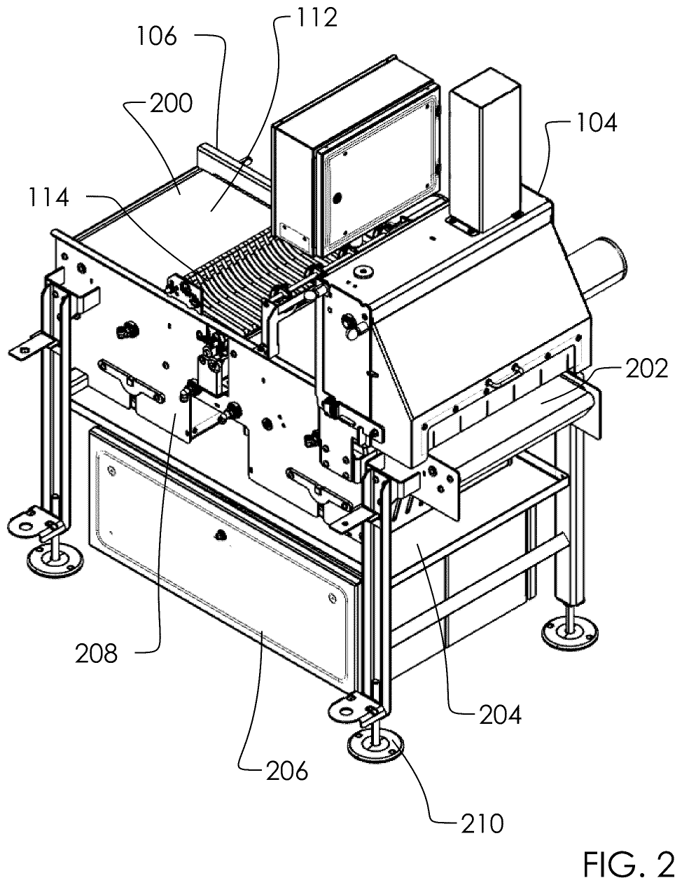

FIG. 2 illustrates a perspective overview of said meat cleaning system 100 from a second viewpoint.

In one embodiment, base 106 can comprise said one or more conveyor assemblies 112 arranged in a substantially horizontal plane. Said one or more conveyor assemblies 112 can comprise a first end 200 and a second end 202.

Said base 106 of said meat cleaning system 100 can comprise a drip tray 204, a storage area 206, and a mechanical enclosure 208, and a plurality of support legs 210.

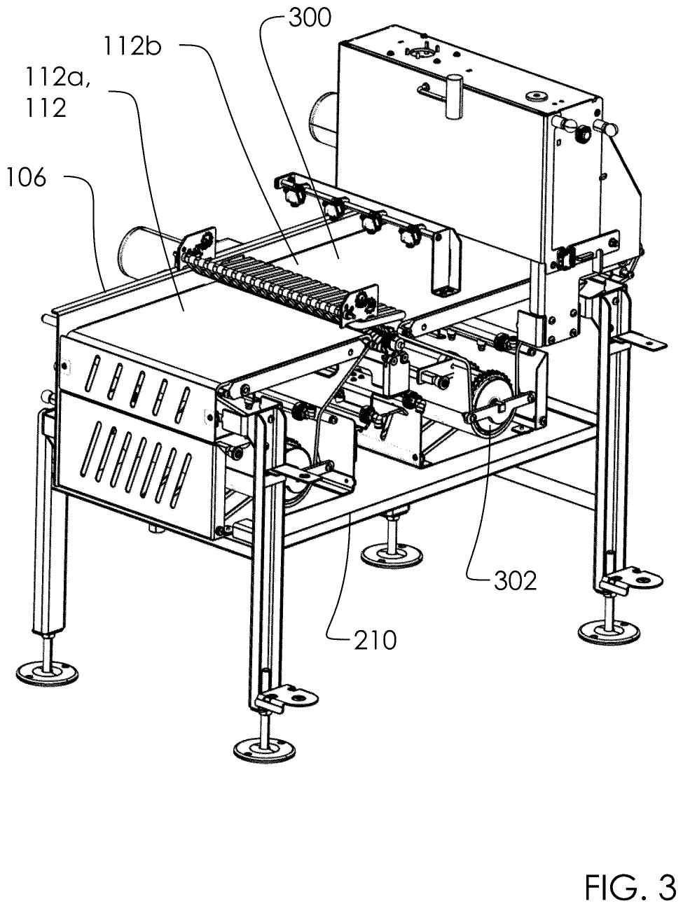

FIG. 3 illustrates a perspective overview of said meat cleaning system 100 with a portion of mechanical enclosure 208 removed.

In one embodiment, said one or more conveyor assemblies 112 can comprise a first conveyor assembly 112a and a second conveyor assembly 112b. Wherein, each among said one or more conveyor assemblies 112 can comprise a conveyor belt 300, and conveyor motor 302. Said first conveyor assembly 112a can be arranged before said first scraping assembly 114 and said second conveyor assembly 112b after said first scraping assembly 114.

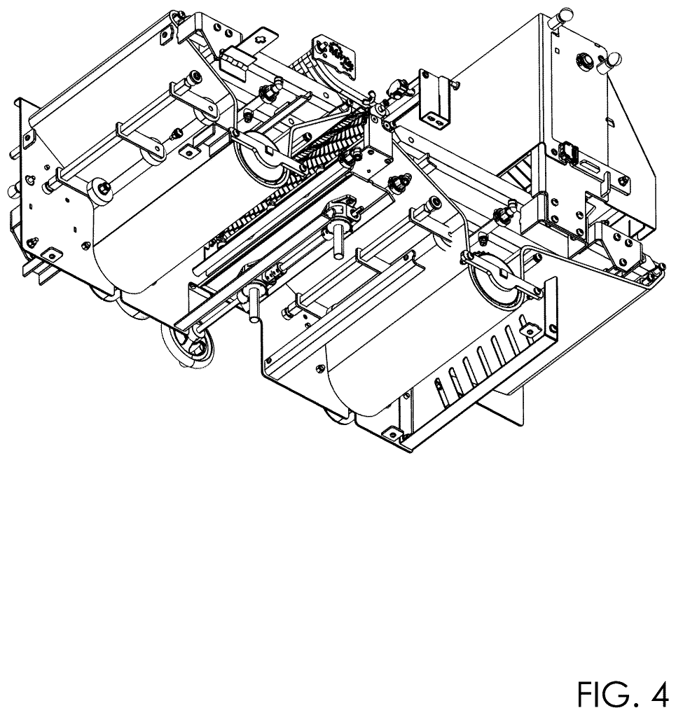

FIG. 4 illustrates a lower perspective view of said meat cleaning system 100.

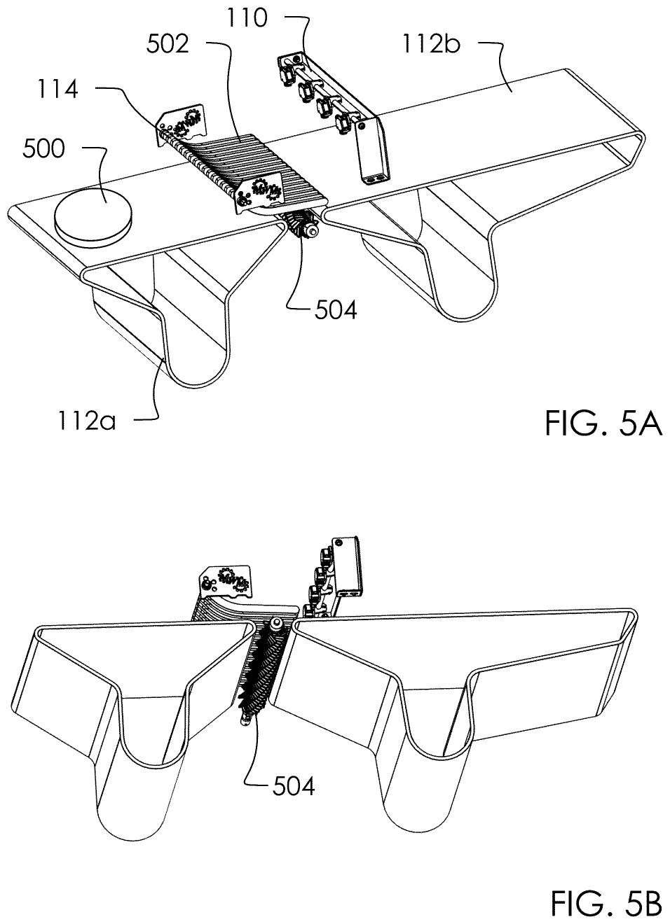

FIG. 5A and 5B illustrate a perspective overview and lower view of said one or more conveyor assemblies 112, said first scraping assembly 114 and said one or more sensors 110 with a meat cut 500.

In one embodiment, said first scraping assembly 114 can comprise a plurality of fingers 502 and a plurality of rotary scrapers 504. In one embodiment, said one or more conveyor assemblies 112 can move said meat cut 500 toward said first scraping assembly 114, wherein said plurality of fingers 502 can press down on a top portion of said meat cut 500 and said plurality of rotary scrapers 504 can scrape a bottom portion of said meat cut 500.

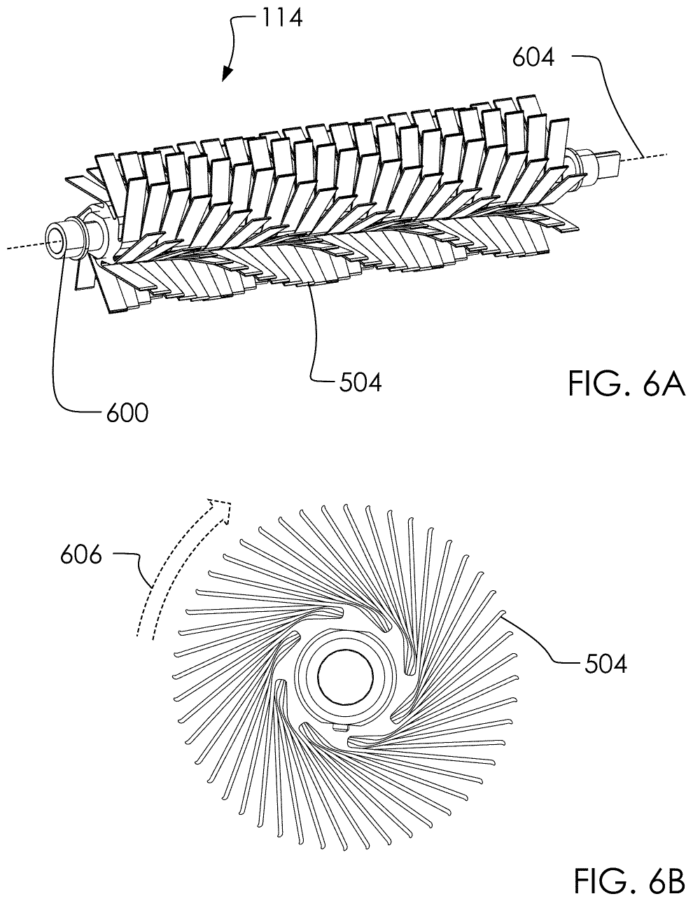

FIG. 6A and 6B illustrate a perspective overview and an elevated side view of said plurality of rotary scrapers 504.

In one embodiment, said first scraping assembly 114 can comprise a spindle 600 having an axis 604 with the plurality of rotary scrapers 504 arranged thereabout.

In one embodiment, said plurality of rotary scrapers 504 can be driven around said axis 604 in a spinning direction 606.

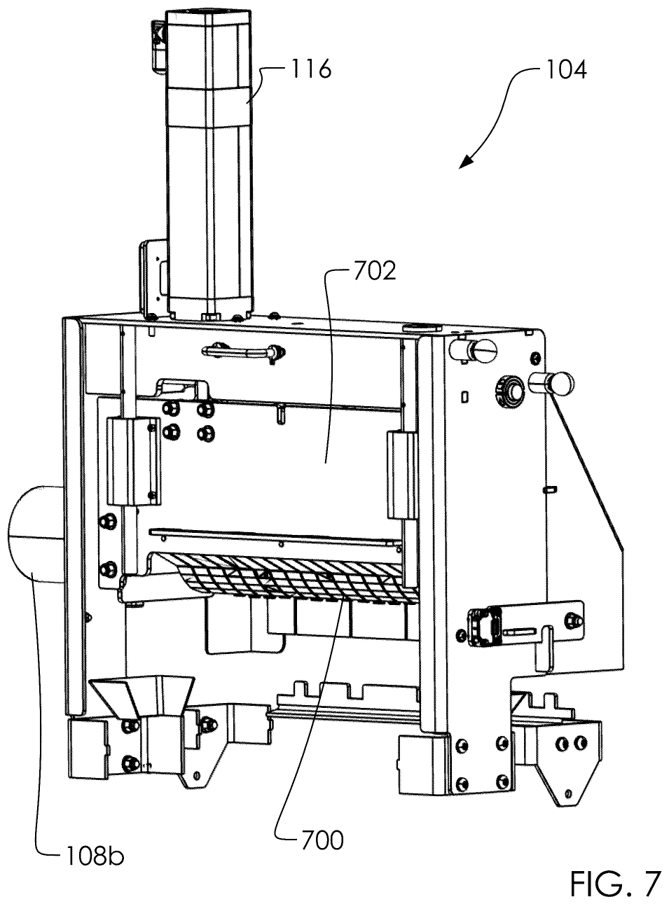

FIG. 7 illustrates a perspective overview of a portion of said tower 104.

In one embodiment, said tower 104 can comprise an encasement 702 configured to protect one or more components therein.

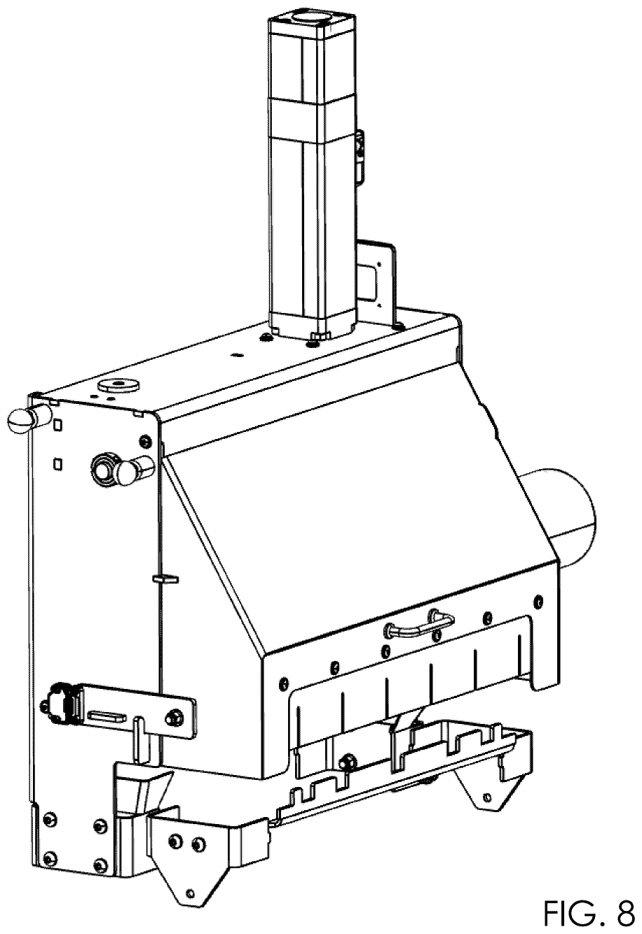

FIG. 8 illustrates a rear side overview of said tower 104.

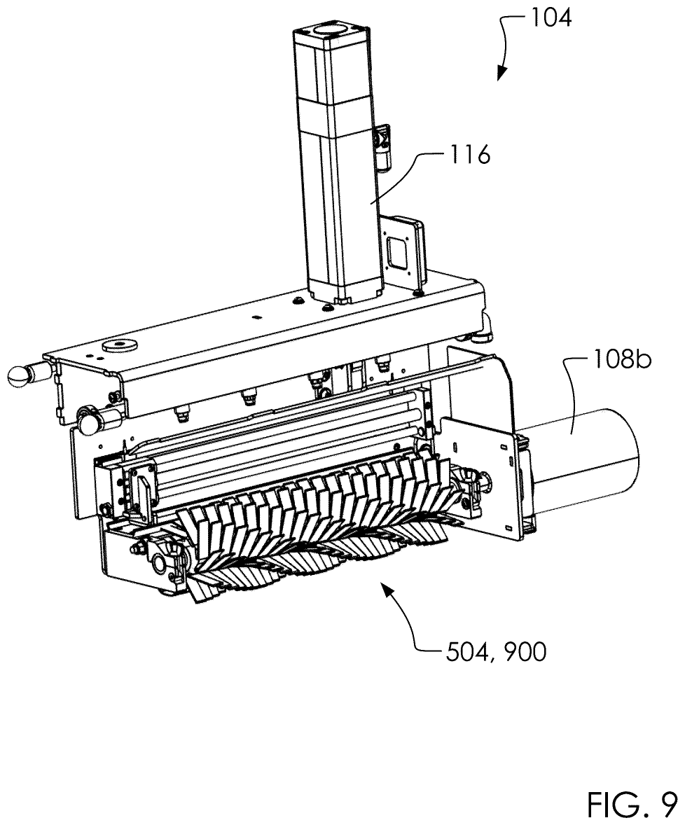

FIG. 9 illustrates a rear side overview of said tower 104 with a portion of said encasement 702 removed.

In one embodiment, said meat cleaning system 100 can comprise a second scraping assembly 900 configured to scape a top portion of said meat cut 500. Said second scraping assembly 900 can comprise a similar part to said plurality of rotary scrapers 504, having plurality of rotary scrapers 504 mounted to said spindle 600 and configured to spin around said axis 604 in said spinning direction 606.

In one embodiment, said second scraping assembly 900 can be mounted within said tower 104, and configured to selectively move up and down using said vertical actuator 116.

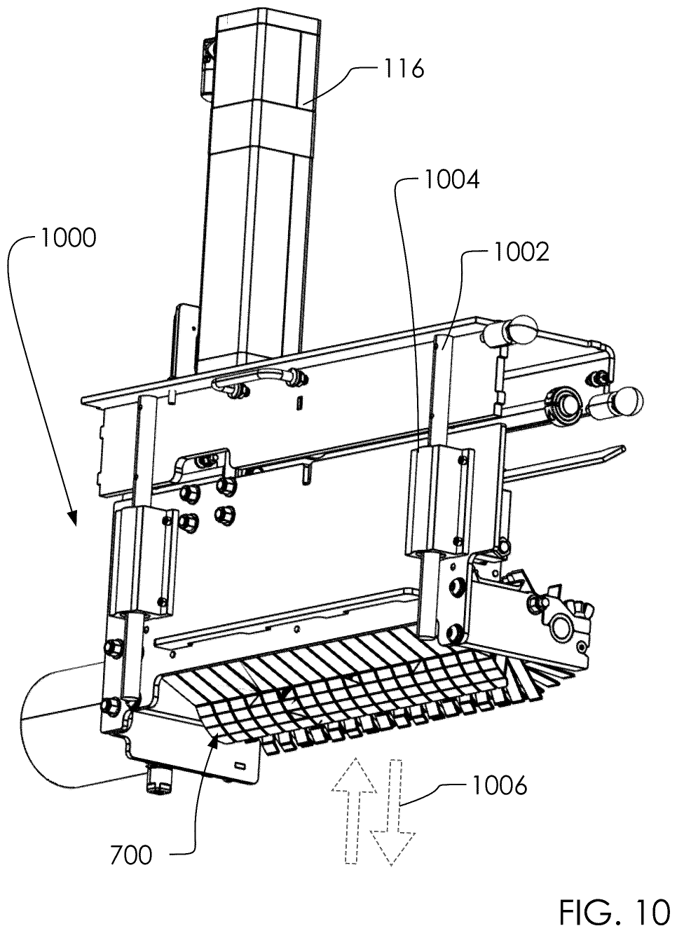

FIG. 10 illustrates a front side overview of said tower 104 with a portion of said encasement 702 removed.

In one embodiment, said meat cleaning system 100 can further comprise a top scraping assembly 1000 configured to selectively adjust a vertical position 1006 of said second scraping assembly 900 relative to said second conveyor assembly 112b. In one embodiment, said vertical actuator 116 can slide a portion of said tower 104 along said vertical position 1006 using a rails 1002 and a slides 1004.

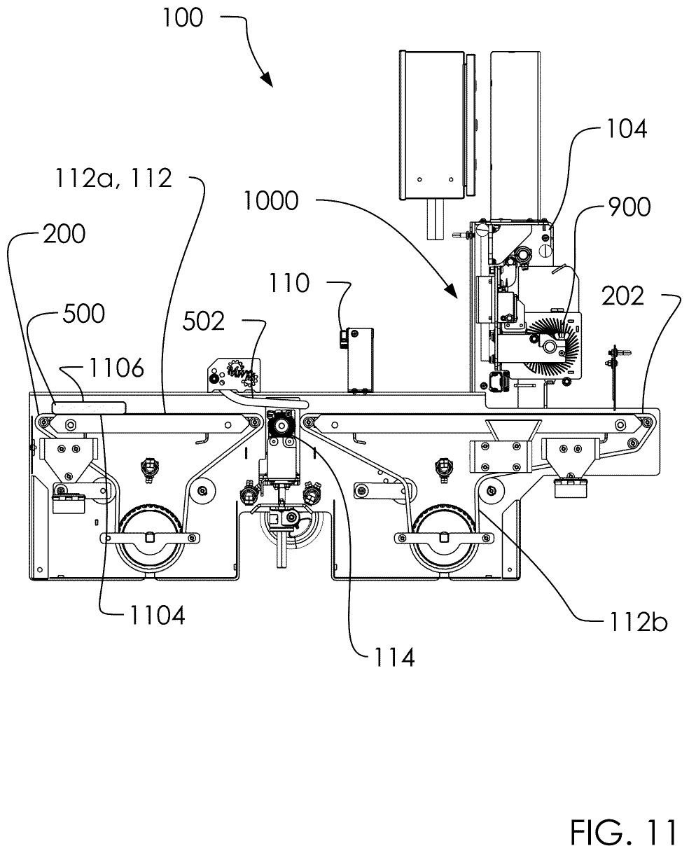

FIG. 11 illustrates an elevated front view of said meat cleaning system 100 showing the arrangement of said first scraping assembly 114, said second scraping assembly 900, and said tower 104, said one or more sensors 110, said top scraping assembly 1000, and said one or more conveyor assemblies 112.

In one embodiment, said meat cleaning system 100 can be configured for moving said meat cut 500 from the first end 200 to the second end 202 of said one or more conveyor assemblies 112, scraping a bottom surface 1104 of said meat cut 500 using said first scraping assembly 114, scanning a top surface 1106 of said meat cut 500, calculating a thickness of said meat cut 500, adjusting said vertical position 1006 of said second scraping assembly 900, and scraping said top surface 1106 of said meat cut 500 using said second scraping assembly 900.

In one embodiment, said one or more sensors 110 can comprise optical sensors, ultrasonic sensors, or other suitable sensors capable of measuring the height of said meat cut 500 above said one or more conveyor assemblies 112. Said one or more sensors 110 can transmit sensor data to said control system 102 through a communication hardware 1208. An application 1204, executed by one or more processors 1206, can process this data to calculate the thickness of said meat cut 500. Based on this calculation, said control system 102 can send a command to said vertical actuator 116 to adjust the vertical position 1006 of said second scraping assembly 900, ensuring effective cleaning of said top surface 1106.

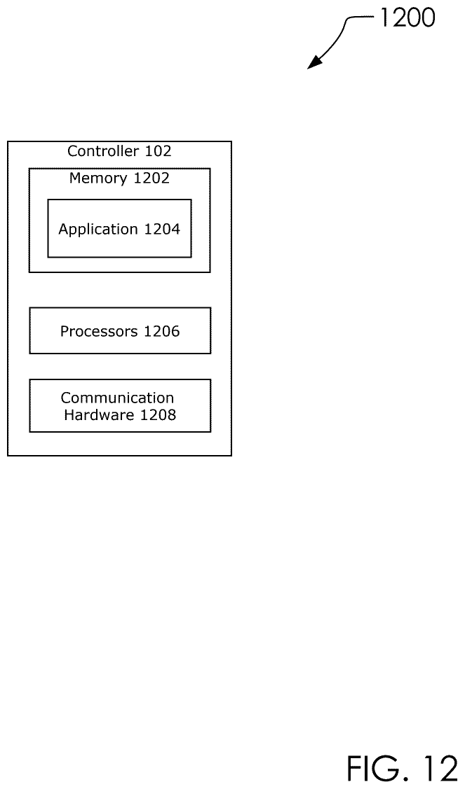

FIG. 12 illustrates a block diagram of said control system 102.

In one embodiment, said control system 102 can comprise a memory 1202 having the application 1204, one or more processors 1206, and the communication hardware 1208. Said application 1204 can be executed using said one or more processors 1206.

In one embodiment, said communication hardware 1208 can communicate with various components within said meat cleaning system 100, such as said top scraping assembly 1000 and said one or more sensors 110, as discussed above. In one embodiment, said one or more sensors 110 can send one or more sensors signals concerning said meat cut 500 to said control system 102 using said communication hardware 1208. Thereafter, said top scraping assembly 1000 can adjust said vertical position 1006 of said second scraping assembly 900 using said communication hardware 1208 based on a calculation made by said application 1204.

### PARTS LIST

said meat cleaning system 100,
said control system 102,
said tower 104,
said base 106,
said first motor 108a,
said second motor 108b,
said one or more motors 108,
said one or more sensors 110,
said first conveyor assembly 112a,
said second conveyor assembly 112b,
said one or more conveyor assemblies 112,
said first scraping assembly 114,
said vertical actuator 116,
said first end 200,
said second end 202,
said drip tray 204,
said storage area 206,
said mechanical enclosure 208,
said plurality of support legs 210,
said conveyor belt 300,
said conveyor motor 302,
said meat cut 500,
said plurality of fingers 502,
said plurality of rotary scrapers 504,
said spindle 600,
said axis 604,
said spinning direction 606,
said encasement 702,
said second scraping assembly 900,
said top scraping assembly 1000,
said rails 1002,
said slides 1004,
said vertical position 1006,
said bottom surface 1104,
said top surface 1106,
said memory 1202,
said application 1204,
said one or more processors 1206, and
said communication hardware 1208.

One preferred embodiment can be found in the original claims, summarized as follows.

The meat cleaning system 100 for cleaning debris from the meat cut 500. Wherein: said meat cleaning system 100 comprises the control system 102, one or more conveyor assemblies 112 having the first end 200 and the second end 202, the first scraping assembly 114 for scraping the bottom surface 1104 of said meat cut 500, the second scraping assembly 900 for scraping the top surface 1106 of said meat cut 500, the tower 104 housing said second scraping assembly 900, the base 106 supporting said one or more conveyor assemblies 112, said first scraping assembly 114 and said tower 104, one or more motors 108 each configured to selectively drive said first scraping assembly 114, said second scraping assembly 900 and said one or more conveyor assemblies 112, and one or more sensors 110 for measuring a thickness of said meat cut 500. Said control system 102 comprises the memory 1202 having the application 1204, one or more processors 1206, and the communication hardware 1208. Said application 1204 can be executed using said one or more processors 1206. Said meat cleaning system 100 can be configured for moving said meat cut 500 from the first end 200 to the second end 202 of said one or more conveyor assemblies 112, scraping the bottom surface 1104 of said meat cut 500 using said first scraping assembly 114, scanning the top surface 1106 of said meat cut 500, calculating a thickness of said meat cut 500, adjusting the vertical position 1006 of said second scraping assembly 900, and scraping said top surface 1106 of said meat cut 500 using said second scraping assembly 900. Said first scraping assembly 114 comprises the plurality of fingers 502 and the plurality of rotary scrapers 504. Said one or more conveyor assemblies 112 can be configured to move said meat cut 500 toward said first scraping assembly 114. Said plurality of fingers 502 can be configured to press down on the top surface 1106 of said meat cut 500 and said plurality of rotary scrapers 504 can scrape the bottom surface 1104 of said meat cut 500.

The meat cleaning system 100 for cleaning debris from the meat cut 500. Wherein: said meat cleaning system 100 comprises the control system 102, one or more conveyor assemblies 112 having the first end 200 and the second end 202, the first scraping assembly 114 for scraping the bottom surface 1104 of said meat cut 500, the second scraping assembly 900 for scraping the top surface 1106 of said meat cut 500, the tower 104 housing said second scraping assembly 900, the base 106 supporting said one or more conveyor assemblies 112, said first scraping assembly 114 and said tower 104, one or more motors 108 each configured to selectively drive said first scraping assembly 114, said second scraping assembly 900 and said one or more conveyor assemblies 112, and one or more sensors 110 for measuring a thickness of said meat cut 500. Said control system 102 comprises the memory 1202 having the application 1204, one or more processors 1206, and the communication hardware 1208. Said application 1204 can be executed using said one or more processors 1206. Said meat cleaning system 100 can be configured for moving said meat cut 500 from the first end 200 to the second end 202 of said one or more conveyor assemblies 112, scraping the bottom surface 1104 of said meat cut 500 using said first scraping assembly 114, scanning the top surface 1106 of said meat cut 500, calculating a thickness of said meat cut 500, adjusting the vertical position 1006 of said second scraping assembly 900, and scraping said top surface 1106 of said meat cut 500 using said second scraping assembly 900.

Said control system 102 comprises the memory 1202 having the application 1204, one or more processors 1206, and the communication hardware 1208. Said application 1204 can be executed using one or more processors 1206.

Said meat cleaning system 100 comprises the top scraping assembly 1000 configured to selectively adjust the vertical position 1006 of said second scraping assembly 900 relative to the second conveyor assembly 112b. Said top scraping assembly 1000 comprises the vertical actuator 116 slides a portion of said tower 104 along said vertical position 1006 using the rails 1002 and the slides 1004.

Each among said first scraping assembly 114 and said second scraping assembly 900 comprise the spindle 600 having the axis 604 with the plurality of rotary scrapers 504 arranged thereabout, and said plurality of rotary scrapers 504 can be driven around said axis 604 in the spinning direction 606.

Said tower 104 comprises the encasement 702 configured to protect one or more components therein.

Said first scraping assembly 114 comprises the plurality of fingers 502 and the plurality of rotary scrapers 504. Said one or more conveyor assemblies 112 can be configured to move said meat cut 500 toward said first scraping assembly 114. Said plurality of fingers 502 can be configured to press down on the top surface 1106 of said meat cut 500 and said plurality of rotary scrapers 504 can scrape the bottom surface 1104 of said meat cut 500.

Said one or more conveyor assemblies 112 comprises the first conveyor assembly 112a and the second conveyor assembly 112b. Wherein, each among said one or more conveyor assemblies 112 comprises the conveyor belt 300, and conveyor motor 302. Said first conveyor assembly 112a can be arranged before said first scraping assembly 114 and said second conveyor assembly 112b after said first scraping assembly 114 with reference to said first end 200 and said second end 202 of said one or more conveyor assemblies 112.

Said base 106 of said meat cleaning system 100 comprises the drip tray 204, the storage area 206, and the mechanical enclosure 208, and the plurality of support legs 210.

A method for cleaning the meat cut 500 using the meat cleaning system 100 can comprise transporting said meat cut 500 along one or more conveyor assemblies 112 from the first end 200 to the second end 202. Scraping the bottom surface 1104 of said meat cut 500 using the first scraping assembly 114. Measuring a thickness of said meat cut 500 using one or more sensors 110. Adjusting the vertical position 1006 of the second scraping assembly 900 based on the measured thickness. Scraping the top surface 1106 of said meat cut 500 using said second scraping assembly 900.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A meat cleaning system for cleaning debris from a meat cut; wherein:
said meat cleaning system comprises
a control system,
one or more conveyor assemblies having a first end and a second end,
a first scraping assembly for scraping a bottom surface of said meat cut,
a second scraping assembly for scraping a top surface of said meat cut,
a tower housing said second scraping assembly,
a base supporting said one or more conveyor assemblies, said first scraping assembly and said tower,
one or more motors each configured to selectively drive said first scraping assembly, said second scraping assembly and said one or more conveyor assemblies, and
one or more sensors for measuring a thickness of said meat cut;
said control system comprises a memory having an application, one or more processors, and a communication hardware;
said application is executed using said one or more processors;
said meat cleaning system is configured for
moving said meat cut from the first end to the second end of said one or more conveyor assemblies,
scraping the bottom surface of said meat cut using said first scraping assembly,
scanning the top surface of said meat cut, calculating a thickness of said meat cut,
adjusting a vertical position of said second scraping assembly, and scraping said top surface of said meat cut using said second scraping assembly;
said first scraping assembly comprises a plurality of fingers and a plurality of rotary scrapers;
said one or more conveyor assemblies are configured to move said meat cut toward said first scraping assembly; and
said plurality of fingers are configured to press down on the top surface of said meat cut and said plurality of rotary scrapers can scrape the bottom surface of said meat cut.

2. A meat cleaning system for cleaning debris from a meat cut; wherein:
said meat cleaning system comprises
a control system,
one or more conveyor assemblies having a first end and a second end,
a first scraping assembly for scraping a bottom surface of said meat cut,
a second scraping assembly for scraping a top surface of said meat cut,
a tower housing said second scraping assembly,
a base supporting said one or more conveyor assemblies, said first scraping assembly and said tower,
one or more motors each configured to selectively drive said first scraping assembly, said second scraping assembly and said one or more conveyor assemblies, and
one or more sensors for measuring a thickness of said meat cut;
said control system comprises a memory having an application, one or more processors, and a communication hardware;
said application is executed using said one or more processors;
said meat cleaning system is configured for
moving said meat cut from the first end to the second end of said one or more conveyor assemblies,
scraping the bottom surface of said meat cut using said first scraping assembly, scanning the top surface of said meat cut, calculating a thickness of said meat cut,
adjusting a vertical position of said second scraping assembly, and
scraping said top surface of said meat cut using said second scraping assembly.

3. The meat cleaning system of claim 2, wherein:
said control system comprises the memory having the application, one or more processors, and the communication hardware; and
said application is executed using one or more processors.

4. The meat cleaning system of claim 2, wherein:
said meat cleaning system comprises a top scraping assembly configured to selectively adjust the vertical position of said second scraping assembly relative to a second conveyor assembly; and
said top scraping assembly comprises a vertical actuator slides a portion of said tower along said vertical position using a rails and a slides.

5. The meat cleaning system of claim 2, wherein:
each among said first scraping assembly and said second scraping assembly comprise a spindle having an axis with a plurality of rotary scrapers arranged thereabout, and
said plurality of rotary scrapers are driven around said axis in a spinning direction.

6. The meat cleaning system of claim 2, wherein:
said tower comprises an encasement configured to protect one or more components therein.

7. The meat cleaning system of claim 2, wherein:
said first scraping assembly comprises a plurality of fingers and a plurality of rotary scrapers;
said one or more conveyor assemblies are configured to move said meat cut toward said first scraping assembly; and
said plurality of fingers are configured to press down on the top surface of said meat cut and said plurality of rotary scrapers can scrape the bottom surface of said meat cut.

8. The meat cleaning system of claim 2, wherein:
said one or more conveyor assemblies comprises a first conveyor assembly and a second conveyor assembly;
wherein, each among said one or more conveyor assemblies comprises a conveyor belt, and conveyor motor; and
said first conveyor assembly is arranged before said first scraping assembly and said second conveyor assembly after said first scraping assembly with reference to said first end and said second end of said one or more conveyor assemblies.

9. The meat cleaning system of claim 2, wherein:
said base of said meat cleaning system comprises a drip tray, a storage area, and a mechanical enclosure, and a plurality of support legs.

10. A method for cleaning a meat cut using a meat cleaning system, comprising:
transporting said meat cut along one or more conveyor assemblies from a first end to a second end;
scraping a bottom surface of said meat cut using a first scraping assembly;
measuring a thickness of said meat cut using one or more sensors;
adjusting a vertical position of a second scraping assembly based on the measured thickness; and
scraping a top surface of said meat cut using said second scraping assembly.
